(19) United States
(12) Patent Application Publication
(10) Pub. No.: US 2025/0251505 A1
(43) Pub. Date: Aug. 7, 2025

(54) SIGNAL PROCESSOR AND RADAR SENSOR INCLUDING THE SAME

(71) Applicant: Samsung Electronics Co., Ltd., Suwon-si (KR)

(72) Inventors: Kyunghwan KIM, Suwon-si (KR); Byeongtaek MOON, Suwon-si (KR); Hyunchul PARK, Suwon-si (KR); Sangmin YOO, Suwon-si (KR); Sangsung LEE, Suwon-si (KR); Joonhoi HUR, Suwon-si (KR)

(73) Assignee: Samsung Electronics Co., Ltd., Suwon-si (KR)

(21) Appl. No.: 19/020,956

(22) Filed: Jan. 14, 2025

(30) Foreign Application Priority Data
Feb. 6, 2024 (KR) 10-2024-0018397
Jun. 18, 2024 (KR) 10-2024-0079096

(51) Int. Cl. G01S 13/526; G01S 7/02

(52) U.S. Cl. CPC G01S 13/526; G01S 7/023

(57) ABSTRACT

A signal processor includes a first filter circuit configured to generate an output signal based on an input signal and a feedback signal, the first filter circuit including a first resistor and a first capacitor, a filtering frequency range of the signal processor being set based on a first resistance of the first resistor and a first capacitance of the first capacitor, a second filter circuit connected to a feedback path of the first filter circuit, the second filter circuit being configured to generate an intermediate signal based on the output signal, and an offset cancellation circuit connected to the feedback path of the first filter circuit, the offset cancellation circuit being configured to generate the feedback signal based on the intermediate signal.

### CROSS-REFERENCE TO RELATED APPLICATION

This application is based on and claims priority under 35 U.S.C. § 119 to Korean Patent Application No. 10-2024-0018397, filed on Feb. 6, 2024, and Korean Patent Application No. 10-2024-0079096, filed on Jun. 18, 2024, in the Korean Intellectual Property Office, the disclosures of each of which are incorporated herein in their entireties by reference.

### BACKGROUND

The inventive concepts relate to a signal processor that may be relatively simply designed.

Electronic devices may include radar sensors to detect distances from objects and speeds of objects. Radar sensors may transmit transmission signals, such as frequency-modulated continuous waveform (FMCW) signals, to objects and may estimate distances from objects and speeds of objects based on reflection signals reflected by the objects.

Radar sensors may perform signal processing on the reflection signals before estimating the distances from the objects and the speeds of the objects. For example, radar sensors may filter reflection signals into signals having intended gains and intended frequency bands by causing the reflection signals to pass through signal processors including high-pass filters, low-pass filters, variable-gain amplifiers, and the like.

Here, in the case where signal processors are designed in structures in which high-pass filters, low-pass filters, variable-gain amplifiers, and the like are connected in a cascaded manner, there may be difficulties in designing circuits when the respective circuits have different operating points. In addition, there may be loss due to impedance between circuits connected in a cascaded manner.

### SUMMARY

The inventive concepts provide a signal processor that may be relatively simply designed. Embodiments provide a signal processor that may be more simply designed even while performing the same operations (or similar operations).

According to an aspect of the inventive concepts, there is provided a signal processor including a first filter circuit configured to generate an output signal based on an input signal and a feedback signal, the first filter circuit including a first resistor and a first capacitor, a filtering frequency range of the signal processor being set based on a first resistance of the first resistor and a first capacitance of the first capacitor, a second filter circuit connected to a feedback path of the first filter circuit, the second filter circuit being configured to generate an intermediate signal based on the output signal, and an offset cancellation circuit connected to the feedback path of the first filter circuit, the offset cancellation circuit being configured to generate the feedback signal based on the intermediate signal.

According to an aspect of the inventive concepts, there is provided a signal processor including a first filter circuit configured to generate an output signal based on an input signal and a feedback signal, a gain of the signal processor being set based on a first resistance of a first resistor in the first filter circuit, a second filter circuit connected to a feedback path of the first filter circuit, the second filter circuit being configured to generate an intermediate signal based on the output signal, and an offset cancellation circuit connected to the feedback path of the first filter circuit, the offset cancellation circuit being configured to generate the feedback signal based on the intermediate signal.

According to an aspect of the inventive concepts, there is provided a radar sensor including processing circuitry configured to generate a transmission signal, amplify the transmission signal to obtain an amplified transmission signal, radiate the amplified transmission signal via a transmission antenna, receive a reception signal via a reception antenna, the reception signal corresponding to a reflection signal resulting from reflection of the transmission signal by an object, and generate an input signal by amplifying the reception signal, and a signal processor including a first filter circuit configured to generate an output signal based on the input signal and a feedback signal, the first filter circuit including a resistor and a capacitor, a filtering frequency range of the signal processor being set based on a resistance of the resistor and a capacitance of the capacitor, a second filter circuit connected to a feedback path of the first filter circuit, the second filter circuit being configured to generate an intermediate signal based on the output signal, and an offset cancellation circuit connected to the feedback path of the first filter circuit, the offset cancellation circuit being configured to generate the feedback signal based on the intermediate signal.

### BRIEF DESCRIPTION OF THE DRAWINGS

Embodiments will be more clearly understood from the following detailed description taken in conjunction with the accompanying drawings in which:

FIG. 1 is a block diagram illustrating a radar sensor according to embodiments;

FIG. 2 is a block diagram illustrating a signal processor that is included in a radar sensor, according to a comparative technique;

FIG. 3 is a block diagram illustrating a signal processor that is included in a radar sensor, according to embodiments;

FIG. 4 is a circuit diagram illustrating an example of a first filter circuit of a signal processor, according to embodiments;

FIG. 5 is a circuit diagram illustrating respective examples of a second filter circuit and an offset cancellation circuit of a signal processor, according to embodiments;

FIG. 6 is a diagram illustrating a graph of frequency response characteristics of a signal processor, according to embodiments;

FIG. 7 is a circuit diagram illustrating another example of a first filter circuit of a signal processor, according to embodiments;

FIG. 8 is a circuit diagram illustrating other respective examples of a second filter circuit and an offset cancellation circuit of a signal processor, according to embodiments;

FIG. 9 is a block diagram illustrating a computing device including a radar sensor, according to embodiments; and

FIG. 10 is a block diagram illustrating an autonomous driving system including a radar sensor, according to embodiments.

### DETAILED DESCRIPTION

Hereinafter, embodiments of the inventive concepts will be described in detail with reference to the accompanying drawings.

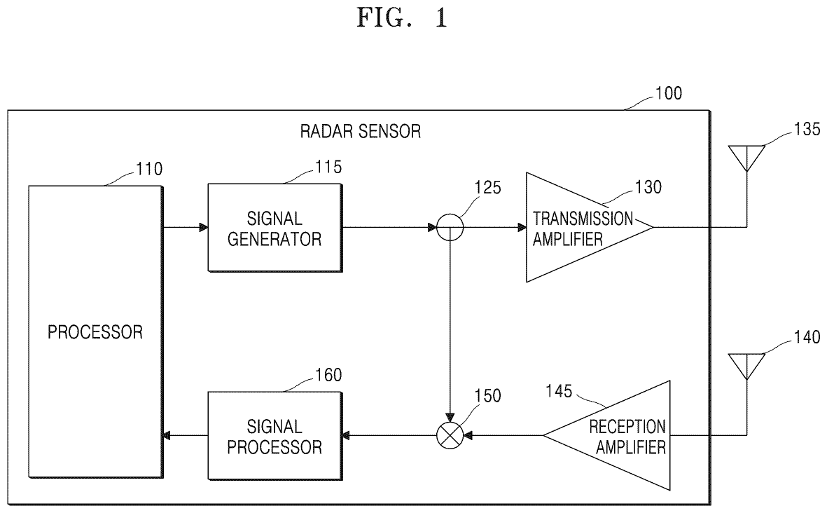

FIG. 1 is a block diagram illustrating a radar sensor according to embodiments.

Referring to FIG. 1, a radar sensor 100 according to embodiments may include a processor 110, a signal generator 115, a signal distributor 125, a transmission amplifier 130, a transmission antenna 135, a reception antenna 140, a reception amplifier 145, a reception frequency converter 150, and/or a signal processor 160.

The radar sensor 100 may detect the distance from an object outside thereof and/or the speed of the object. The radar sensor 100 may generate and radiate a signal to the outside thereof, may receive a reflection signal resulting from turning-back of the radiated signal reflected by an object, and may predict the distance from the object and/or the speed of the object based on the reflection signal.

The processor 110 may control all operations of the radar sensor 100. The processor 110 may transmit a control signal for generating a transmission signal to the signal generator 115, and may predict the distance from the object and/or the speed of the object based on a signal that is output from the signal processor 160.

The signal generator 115 may generate a transmission signal based on the control signal received from the processor 110. In embodiments, the transmission signal may be a frequency-modulated continuous waveform (FMCW) signal that is generated based on a preset (or alternatively, given) frequency modulation pattern. The FMCW signal generated by the signal generator 115 may have a waveform in which a carrier frequency gradually increases in some time periods and gradually decreases in other time periods.

The signal generator 115 may include a voltage-controlled oscillator (VCO) circuit for generating various oscillation frequencies and a phase-locked loop (PLL) circuit for improving the stability of an output frequency of the VCO circuit.

The signal distributor 125 may receive the transmission signal generated by the signal generator 115. The signal distributor 125 may divide and transfer the transmission signal to the transmission amplifier 130 and the reception frequency converter 150.

The transmission amplifier 130 may amplify the transmission signal received from the signal distributor 125. The transmission amplifier 130 may amplify and transfer the transmission signal to the transmission antenna 135.

The transmission antenna 135 may radiate the amplified transmission signal received from the transmission amplifier 130. Although FIG. 1 illustrates an example in which the radar sensor 100 includes one transmission antenna 135 (e.g., only one transmission antenna 135), the inventive concepts are not limited thereto, and the radar sensor 100 may include one or more transmission antennas 135. The one or more transmission antennas 135 may each radiate a transmission signal in a time period of which each transmission antenna 135 is in charge (e.g., a corresponding time period assigned to each respect transmission antenna 135), according to a time division method.

The reception antenna 140 may receive, as a reception signal, a reflection signal resulting from turning-back of the radiated transmission signal reflected by an object. Although FIG. 1 illustrates an example in which the radar sensor 100 includes one reception antenna 140 (e.g., only one reception antenna 140), the inventive concepts are not limited thereto, and the radar sensor 100 may include one or more reception antennas 140.

The reception amplifier 145 may amplify the reception signal received via the reception antenna 140. The reception amplifier 145 may amplify and transfer the reception signal to the reception frequency converter 150.

The reception frequency converter 150 may receive the reception signal amplified by the reception amplifier 145 and the transmission signal distributed by the signal distributor 125. The reception frequency converter 150 may modulate the reception signal into a baseband signal by multiplying the reception signal by the transmission signal received from the signal distributor 125. The reception frequency converter 150 may transfer the modulated reception signal to the signal processor 160.

The signal processor 160 may perform signal processing on the modulated reception signal received via the reception frequency converter 150. The signal processor 160 may perform processing, such as high-pass filtering, low-pass filtering, variable-gain amplification, or offset cancellation, on a reception signal (e.g., on the modulated reception signal).

In embodiments, the signal processor 160 may include a first filter circuit, a second filter circuit connected to a feedback path of the first filter circuit, and/or an offset cancellation circuit connected to the feedback path of the first filter circuit.

Here, a filtering frequency range of the signal processor 160 may be set based on the resistance of a resistor, which is included in the first filter circuit, and the capacitance of a capacitor, which is included in the first filter circuit. In addition, the gain of the signal processor 160 may be set based on the resistance of the resistor of the first filter circuit.

More detailed structures and operations of the signal processor 160 are described below with reference to FIG. 3 and figures subsequent to FIG. 3.

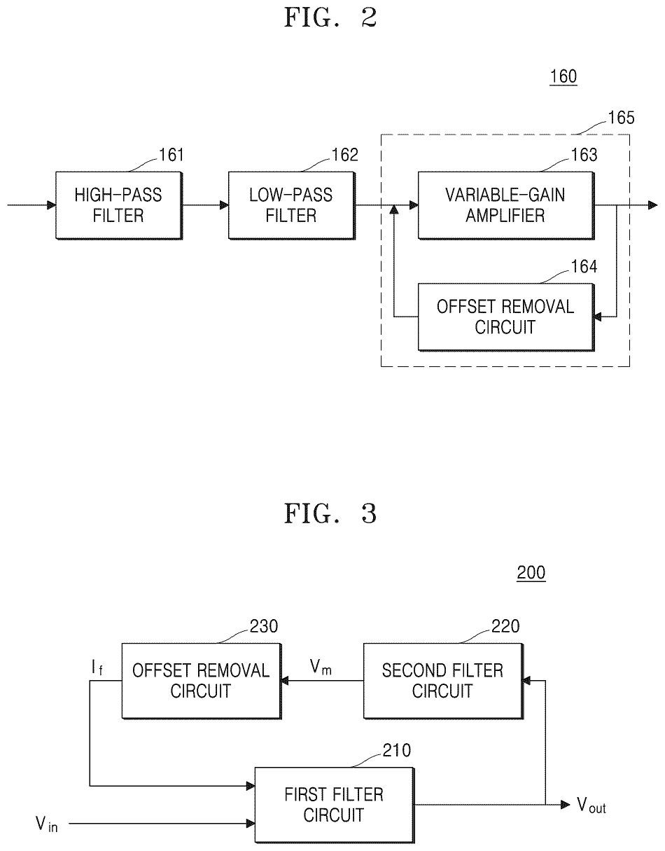

FIG. 2 is a block diagram illustrating a signal processor that is included in a radar sensor, according to a comparative technique.

Referring to FIG. 2, a signal processor 160 that is included in a radar sensor 100 according to the comparative technique may include a high-pass filter 161, a low-pass filter 162, and an amplification circuit 165.

The high-pass filter 161 may receive a reception signal that is amplified by the reception amplifier 145 and modulated by the reception frequency converter 150. The high-pass filter 161 may pass a frequency component, which is equal to or greater than a preset (or alternatively, given) cut-off frequency, out of a signal that is input thereto.

The low-pass filter 162 may receive a signal having passed through the high-pass filter 161. The low-pass filter 162 may pass a frequency component, which is equal to or less than a preset (or alternatively, given) cut-off frequency, out of the received signal. The cut-off frequency of the low-pass filter 162 may be greater than the cut-off frequency of the high-pass filter 161.

The amplification circuit 165 may include a variable-gain amplifier 163 and an offset cancellation circuit 164 (may also be referred to herein as an offset removal circuit 164). Here, because the offset cancellation circuit 164 of the amplification circuit 165 is connected to a feedback path of the variable-gain amplifier 163, the variable-gain amplifier 163 and the offset cancellation circuit 164 may be designed at a time. For example, relevant parameters of components (e.g., resistances of resistors, capacitances of capacitors, etc.) included in the variable-gain amplifier 163 and the offset cancellation circuit 164 may be set (or defined, configured, etc.) together (e.g., at a single point in time).

The variable-gain amplifier 163 may receive a signal having passed through the low-pass filter 162. The variable-gain amplifier 163 may amplify the signal having passed through the low-pass filter 162 to cause the signal to have a targeted signal strength.

The offset cancellation circuit 164 may receive a signal having passed through the variable-gain amplifier 163. The offset cancellation circuit 164 may be located on the feedback path of the variable-gain amplifier 163. The offset cancellation circuit 164 may remove a direct-current (DC) offset due to errors in an oscillator, a switching device, and the like, which are in the radar sensor 100, from the signal having passed through the variable-gain amplifier 163.

When the high-pass filter 161, the low-pass filter 162, and the amplification circuit 165 are connected in a cascaded structure as in the signal processor 160 according to the comparative technique, the high-pass filter 161, the low-pass filter 162, and the amplification circuit 165 may be individually designed, and the signal processor 160 may be configured by connecting the high-pass filter 161, the low-pass filter 162, and the amplification circuit 165, which are individually designed, to each other. For example, relevant parameters of components (e.g., resistances of resistors, capacitances of capacitors, etc.) included in each among the high-pass filter 161, the low-pass filter 162, and the amplification circuit 165 may be initially set (or defined, configured, etc.) separately. Subsequently, the relevant parameters of components (e.g., resistances of resistors, capacitances of capacitors, etc.) initially set for each among the high-pass filter 161, the low-pass filter 162, and the amplification circuit 165 may be adjusted (or corrected, refined, etc.) with respect to the combination of the high-pass filter 161, the low-pass filter 162, and the amplification circuit 165. Here, because the high-pass filter 161, the low-pass filter 162, and the amplification circuit 165 are individually designed, operating points of the respective circuits need to (or otherwise, should) be consistent with each other, and thus, there may be a difficulty in circuit design. In addition, there may be a loss due to impedance between the high-pass filter 161, the low-pass filter 162, and the amplification circuit 165 connected in a cascaded manner.

FIG. 3 is a block diagram illustrating a signal processor that is included in a radar sensor, according to embodiments.

Referring to FIG. 3, a signal processor 200 according to embodiments may include a first filter circuit 210, a second filter circuit 220, and/or an offset cancellation circuit 230. Here, the signal processor 200 of FIG. 3 may be used as the signal processor 160 of FIG. 1.

The signal processor 200 may receive an input signal Vᵢₙ. The input signal Vᵢₙ may be a signal that is input to the signal processor 160 of the radar sensor 100, and may be a reception signal amplified by the reception amplifier 145 and modulated by the reception frequency converter 150. The signal processor 200 may generate an output signal Vₒᵤₜ by performing signal processing on the input signal Vᵢₙ generated based the reception signal.

The first filter circuit 210 may receive the input signal Vᵢₙ. In addition, the first filter circuit 210 may receive a feedback signal I_{f}. The feedback signal I_{f} may be a signal generated by the second filter circuit 220 and the offset cancellation circuit 230.

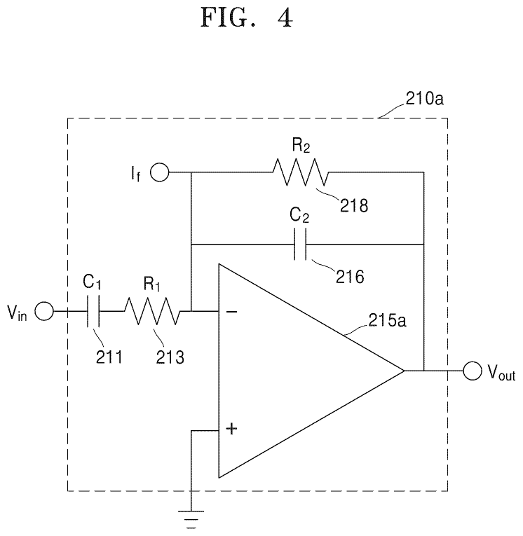

The first filter circuit 210 may include a band-pass filter that passes a signal within a specific frequency range. The first filter circuit 210 may generate the output signal Vₒᵤₜ by passing, out of the input signal Vᵢₙ, only a signal within the specific frequency range. An example of the first filter circuit 210 may be described in more detail with reference to FIG. 4.

FIG. 4 is a circuit diagram illustrating an example of a first filter circuit of a signal processor, according to embodiments.

Referring to FIG. 4, in embodiments, the first filter circuit 210a may include a first capacitor 211, a first resistor 213, an amplifier 215a, a second capacitor 216, and/or a second resistor 218. In the example of FIG. 4, the first filter circuit 210a may be a circuit designed in a single mode (e.g., not a differential mode).

The first capacitor 211 may receive an input signal Vᵢₙ. That is, the first capacitor 211 may receive the input signal Vᵢₙ via one end thereof. The first capacitor 211 may have a first capacitance C₁.

The first resistor 213 may be connected in series to the first capacitor 211. Here, one end of the first resistor 213 may be connected to the other end of the first capacitor 211. The first resistor 213 may have a first resistance R₁.

The amplifier 215a may be connected to the first resistor 213 via an input terminal of the amplifier 215a. Here, a first input terminal of the amplifier 215a may be connected to the other end of the first resistor 213. A second input terminal of the amplifier 215a may be connected to a ground terminal. The amplifier 215a may output an output signal Vₒᵤₜ via an output terminal thereof.

The second capacitor 216 may be connected in parallel to the amplifier 21a5. Here, one end (e.g., a first end) of the second capacitor 216 may be connected to the first input terminal of the amplifier 215a, and the other end (e.g., a second end) of the second capacitor 216 may be connected to the output terminal of the amplifier 215a.

The second capacitor 216 may receive a feedback signal I_{f}. That is, the second capacitor 216 may receive the feedback signal I_{f} via the one end (e.g., the first end) thereof. The second capacitor 216 may have a second capacitance C₂.

The second resistor 218 may be connected in parallel to the amplifier 215a. Here, one end (e.g., a first end) of the second resistor 218 may be connected to the first input terminal of the amplifier 215a, and the other end (e.g., a second end) of the second resistor 218 may be connected to the output terminal of the amplifier 215a.

The second resistor 218 may receive the feedback signal I_{f}. Here, the second resistor 218 may receive the feedback signal I_{f} via the one end (e.g., the first end) thereof. The second resistor 218 may have a second resistance R₂.

When the first filter circuit 210a has a structure shown in FIG. 4, by applying Kirchhoff's laws around the first input terminal of the amplifier 215a of the first filter circuit 210a, Equation 1 shown below may be derived.

$$\frac{{v}_{i} ( s )}{{R}_{1} + \frac{1}{{sC}_{1}}} = \frac{{v}_{o} ( s )}{\frac{{R}_{2}}{1 + {sR}_{2} {C}_{2}}} + {i}_{f} ( s ) \qquad [ Equation 1 ]$$

In Equation 1, vᵢ(s) may be a result of Laplace transformation of the input signal Vᵢₙ, vₒ(s) may be a result of Laplace transformation of the output signal Vₒᵤₜ, i_{f}(s) may be a result of Laplace transformation of the feedback signal I_{f}, and s may be a Laplace variable.

Referring again to FIG. 3, the second filter circuit 220 may be connected to a feedback path of the first filter circuit 210. Here, the second filter circuit 220, together with the offset cancellation circuit 230, may constitute the feedback path of the first filter circuit 210. The second filter circuit 220 may be connected to an output terminal of the first filter circuit 210. The second filter circuit 220 may receive the output signal Vₒᵤₜ.

The second filter circuit 220 may include a low-pass filter that passes a signal with a specific frequency or less. The second filter circuit 220 may generate an intermediate signal Vₘ by passing only a signal with the specific frequency or less out of the output signal Vₒᵤₜ.

The offset cancellation circuit 230 may be connected to the feedback path of the first filter circuit 210. Here, the offset cancellation circuit 230, together with the second filter circuit 220, may constitute the feedback path of the first filter circuit 210. The offset cancellation circuit 230 may be connected to an output terminal of the second filter circuit 220. The offset cancellation circuit 230 may receive the intermediate signal Vₘ.

The offset cancellation circuit 230 may remove a DC offset from a signal having passed through the second filter circuit 220.

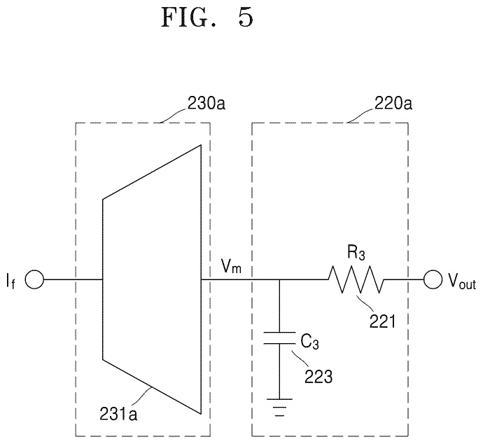

Respective examples of the second filter circuit 220 and the offset cancellation circuit 230 may be described in more detail with reference to FIG. 5.

FIG. 5 is a circuit diagram illustrating respective examples of a second filter circuit and an offset cancellation circuit of a signal processor, according to embodiments.

Referring to FIG. 5, in embodiments, the second filter circuit 220a may include a third resistor 221 and/or a third capacitor 223, and the offset cancellation circuit 230a may include a voltage-to-current converter 231a. In the example of FIG. 5, the second filter circuit 220a and the offset cancellation circuit 230a may each be a circuit designed in a single mode and may be used together with the first filter circuit 210a designed in a single mode as in the example of FIG. 4.

The third resistor 221 may receive an output signal Vₒᵤₜ. That is, the third resistor 221 may receive the output signal Vₒᵤₜ via one end thereof. The third resistor 221 may have a third resistance R₃.

The third capacitor 223 may be connected to the third resistor 221. Here, one end of the third capacitor 223 may be connected to the other end of the third resistor 221. The other end of the third capacitor 223 may be connected to a ground terminal. The third capacitor 223 may have a third capacitance C₃.

Here, the intermediate signal Vₘ may be output via a terminal between the third resistor 221 and the third capacitor 223.

When the second filter circuit 220a has a structure shown in FIG. 5, by applying Kirchhoff's laws around the terminal between the third resistor 221 and the third capacitor 223, Equation 2 shown below may be derived.

$$\frac{{v}_{o} ( s ) - {v}_{m} ( s )}{{R}_{3}} = {sC}_{3} {v}_{m} ( s ) \qquad [ Equation 2 ]$$

In Equation 2, vₘ(s) may be a result of Laplace transformation of the intermediate signal Vₘ.

An input terminal of the voltage-to-current converter 231a may be connected to the terminal between the third resistor 221 and the third capacitor 223. Here, the voltage-to-current converter 231a may receive the intermediate signal Vₘ via the input terminal thereof. The voltage-to-current converter 231a may output a feedback signal I_{f} via an output terminal thereof.

When the offset cancellation circuit 230a has a structure shown in FIG. 5, a relationship between a feedback signal and an intermediate signal may be represented by Equation 3 shown below.

$${i}_{f} ( s ) = {g}_{m} {v}_{m} ( s ) \qquad [ Equation 3 ]$$

In Equation 3, gₘ may be a gain by the voltage-to-current converter 231a.

Referring again to FIG. 3, when the first filter circuit 210 of the signal processor 200 has a structure shown in FIG. 4 and the second filter circuit 220 and the offset cancellation circuit 230 of the signal processor 200 have structures shown in FIG. 5, a transfer function of the signal processor 200, which is obtained by combining Equations 1 to 3 together, may be represented by Equation 4 shown below.

$$H ( s ) = \qquad [ Equation 4 ]$$

$$\frac{{v}_{o} ( s )}{{v}_{i} ( s )} = \frac{1}{{R}_{1} {C}_{2}} \times \frac{s ( s + \frac{1}{{R}_{3} {C}_{3}} )}{( s + \frac{1}{{R}_{1} {C}_{1}} ) ( {s}^{2} + ( \frac{1}{{R}_{2} {C}_{2}} + \frac{1}{{R}_{3} {C}_{3}} ) s + \frac{{R}_{2} {g}_{m} + 1}{{R}_{2} {R}_{3} {C}_{2} {C}_{3}} )}$$

In Equation 4, H(s) may be a result of Laplace transformation of the transfer function of the signal processor 200.

As such, the signal processor 200 may have two zeros and three poles. Here, to cause the signal processor 200 to have an intended filtering frequency range, settings described below may be performed.

First, the signal processor 200 may be set such that a product of the second resistance R₂ and the gain gₘ of the offset cancellation circuit 230a is as great as a first reference multiple (for example, 100 times) or more of a reference gain (for example, 1). According to embodiments, a reference multiple and/or a reference gain as used herein may refer to an integer value). That is, the signal processor 200 may be set to satisfy Inequality 5 shown below.

$${R}_{2} {g}_{m} ≫ 1 \qquad [ Inequality 5 ]$$

By using Inequality 5, Equation 4 may be approximated to Equation 6 shown below.

$$H ( s ) \approx \qquad [ Equation 6 ]$$

$$\frac{1}{{R}_{1} {C}_{2}} \times \frac{s ( s + \frac{1}{{R}_{3} {C}_{3}} )}{( s + \frac{1}{{R}_{1} {C}_{1}} ) ( {s}^{2} + ( \frac{1}{{R}_{2} {C}_{2}} + \frac{1}{{R}_{3} {C}_{3}} ) s + \frac{{R}_{2} {g}_{m}}{{R}_{2} {R}_{3} {C}_{2} {C}_{3}} )}$$

That is, the constant term of the quadratic expression in the denominator in Equation 4 may be simplified as in Equation 6.

Next, the signal processor 200 may be set such that a value obtained by dividing the product of the second resistance R₂ and the gain gₘ of the offset cancellation circuit 230a by a product of the third resistance R₃ and the third capacitance C₃ is approximated (or may be set to be equal) to a reciprocal of a product of the first resistance R₁ and the first capacitance C₁. That is, the signal processor 200 may be set to satisfy Equation 7 shown below.

$$\frac{{R}_{2} {g}_{m}}{{R}_{3} {C}_{3}} \approx \frac{1}{{R}_{1} {C}_{1}} \qquad [ Equation 7 ]$$

By using Equation 7, Equation 6 may be approximated to Equation 8 shown below.

$$H ( s ) \approx \qquad [ Equation 8 ]$$

$$\frac{1}{{R}_{1} {C}_{2}} \times \frac{s ( s + \frac{1}{{R}_{3} {C}_{3}} )}{( s + \frac{1}{{R}_{1} {C}_{1}} ) ( {s}^{2} + ( \frac{1}{{R}_{2} {C}_{2}} + \frac{1}{{R}_{3} {C}_{3}} ) s + \frac{1}{{R}_{1} {C}_{1}} \frac{1}{{R}_{2} {C}_{2}} )}$$

That is, the constant term of the quadratic expression in the denominator in Equation 6 may be further simplified as in Equation 8.

Next, to determine the positions of zeros and poles, the signal processor 200 may be set such that the reciprocal of the product of the second resistance R₂ and the second capacitance C₂ is as great as a second reference multiple (for example, 100 times) or more of the reciprocal of the product of the first resistance R₁ and the first capacitance C₁, and such that the reciprocal of the product of the first resistance R₁ and the first capacitance C₁ is as great as a third reference multiple (for example, 100 times) or more of the reciprocal of the product of the third resistance R₃ and the third capacitance C₃. That is, the signal processor 200 may be set to satisfy Inequality 9 shown below.

$$\frac{1}{{R}_{2} {C}_{2}} ≫ \frac{1}{{R}_{1} {C}_{1}} ≫ \frac{1}{{R}_{3} {C}_{3}} \qquad [ Inequality 9 ]$$

By using Equation 9, Equation 8 may be approximated to Equation 10 shown below.

$$H ( s ) \approx \frac{1}{{R}_{1} {C}_{2}} \times \frac{s ( s + \frac{1}{{R}_{3} {C}_{3}} )}{{( s + \frac{1}{{R}_{1} {C}_{1}} )}^{2} ( s + \frac{1}{{R}_{2} {C}_{2}} )} \qquad [ Equation 10 ]$$

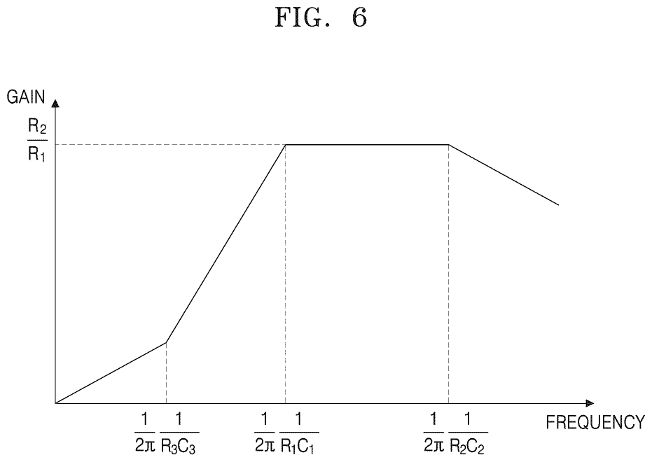

Here, a graph of frequency response characteristics of the signal processor 200 satisfying Equation 10 may be as shown in FIG. 6.

FIG. 6 is a diagram illustrating a graph of frequency response characteristics of a signal processor, according to embodiments.

Referring to FIG. 6, the graph illustrating the frequency response characteristics of the signal processor 200 satisfying Equation 10 may be checked. Because the positions of zeros and poles are determined as in Equation 9, the gain of the signal processor 200 may increase (for example, +20 dB/decade) firstly from the point at which the frequency is 0, may increase (for example, +40 dB/decade) secondly from the point at which the frequency is 1/(2πR₃C₃), may have a constant value from the point at which the frequency is 1/(2πR₁C₁), and may decrease (for example, −20 dB/decade) firstly from the point at which the frequency is 1/(2πR₂C₂).

Referring to the graph of FIG. 6 and Equation 10, the filtering frequency range of the signal processor 200 may range from a frequency corresponding to the reciprocal of the product of the first resistance R₁ and the first capacitance C₁ to a frequency corresponding to the reciprocal of the product of the second resistance R₂ and the second capacitance C₂. That is, the filtering frequency range of the signal processor 200 may be set based on the respective resistances R₁ and R₂ of the resistors 213 and 218 of the first filter circuit 210a and the respective capacitances C₁ and C₂ of the capacitors 211 and 216 of the first filter circuit 210a.

In addition, the gain of the signal processor 200 may be derived as Equation 11 shown below from Equation 10.

$${H ( s ) \vert}_{s = j {ω}_{BP}} \approx \frac{1}{{R}_{1} {C}_{2}} \times \frac{j {ω}_{BP} ( j {ω}_{BP} )}{{( j {ω}_{BP} )}^{2} ( \frac{1}{{R}_{2} {C}_{2}} )} = \frac{{R}_{2}}{{R}_{1}} \qquad [ Equation 11 ]$$

In Equation 11, ω_{BP} may be an arbitrary (or alternatively, given) frequency within the filtering frequency range of the signal processor 200.

Referring to the graph of FIG. 6 and Equation 11, the gain of the signal processor 200 may be set to be inversely proportional to the first resistance R₁ and to be proportional to the second resistance R₂. The gain of the signal processor 200 may be set based on the respective resistances R₁ and R₂ of the resistors 213 and 218 of the first filter circuit 210a.

Referring again to FIG. 3, the signal processor 200 according to embodiments may be implemented by the first filter circuit 210, the second filter circuit 220, and the offset cancellation circuit 230, which are included in one feedback loop, and thus, the signal processor 200 may have a relatively simple structure. Therefore, because the whole signal processor 200 may be designed at a time, the signal processor 200 may be more simply designed.

In addition, because the filtering frequency range of the signal processor 200 according to embodiments may be set based on the respective resistances R₁ and R₂ of the resistors 213 and 218 of the first filter circuit 210a and the respective capacitances C₁ and C₂ of the capacitors 211 and 216 of the first filter circuit 210a, a frequency band of a signal having passed through the signal processor 200 may be simply adjusted.

Furthermore, because the gain of the signal processor 200 according to embodiments may be set based on the respective resistances R₁ and R₂ of the resistors 213 and 218 of the first filter circuit 210a, the gain of the signal processor 200 may be simply adjusted.

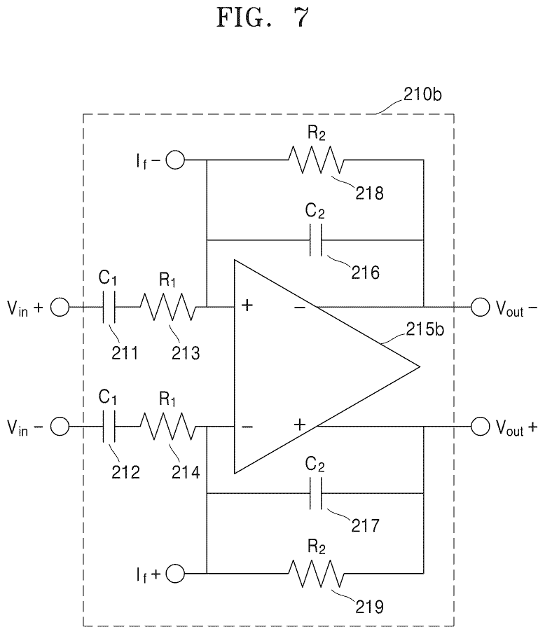

FIG. 7 is a circuit diagram illustrating another example of a first filter circuit of a signal processor, according to embodiments.

Referring to FIG. 7, in embodiments, the first filter circuit 210b may include a pair of first capacitors 211 and 212, a pair of first resistors 213 and 214, an amplifier 215b, a pair of second capacitors 216 and 217, and/or a pair of second resistors 218 and 219. In the example of FIG. 7, the first filter circuit 210b may be a circuit designed in a differential mode.

The pair of first capacitors 211 and 212 may respectively receive a pair of input signals Vᵢₙ+ and Vᵢₙ−. That is, the pair of first capacitors 211 and 212 may respectively receive the pair of input signals Vᵢₙ+ and Vᵢₙ− via one-side ends (e.g., first ends) thereof. The pair of first capacitors 211 and 212 may each have a first capacitance C₁.

The pair of first resistors 213 and 214 may be respectively connected in series to the pair of first capacitors 211 and 212. Here, one-side ends (e.g., first ends) of the pair of first resistors 213 and 214 may be respectively connected to the other-side ends (e.g., second ends) of the pair of first capacitors 211 and 212. The pair of first resistors 213 and 214 may each have a first resistance R₁.

The amplifier 215b may be connected to the pair of first resistors 213 and 214 respectively via a pair of input terminals of the amplifier 215b. Here, the pair of input terminals of the amplifier 215b may be respectively connected to the other-side ends (e.g., second ends) of the pair of first resistors 213 and 214. The amplifier 215b may output a pair of output signals Vₒᵤₜ+ and Vₒᵤₜ− respectively via a pair of output terminals.

The pair of second capacitors 216 and 217 may each be connected in parallel to the amplifier 215b. Here, one-side ends (e.g., first ends) of the pair of second capacitors 216 and 217 may be respectively connected to the pair of input terminals of the amplifier 215b, and the other-side ends (e.g., second ends) of the pair of second capacitors 216 and 217 may be respectively connected to the pair of output terminals of the amplifier 215b.

The pair of second capacitors 216 and 217 may respectively receive a pair of feedback signals I_{f}+ and I_{f}−. That is, the pair of second capacitors 216 and 217 may respectively receive the pair of feedback signals I_{f}+ and I_{f}− via the one-side ends (e.g., first ends) thereof. The pair of second capacitors 216 and 217 may each have a second capacitance C₂.

The pair of second resistors 218 and 219 may each be connected in parallel to the amplifier 215b. Here, one-side ends (e.g., first ends) of the pair of second resistors 218 and 219 may be respectively connected to the pair of input terminals of the amplifier 215b, and the other-side ends (e.g., second ends) of the pair of second resistors 218 and 219 may be respectively connected to the pair of output terminals of the amplifier 215b.

The pair of second resistors 218 and 219 may respectively receive the pair of feedback signals I_{f}+ and I_{f}−. Here, the pair of second resistors 218 and 219 may respectively receive the pair of feedback signals I_{f}+ and I_{f}− via the one-side ends (e.g., first ends) thereof. The pair of second resistors 218 and 219 may each have a second resistance R₂.

Equation 1 may also be derived for the first filter circuit 210b shown in FIG. 7, and here, vᵢ(s) may be obtained by performing Laplace transformation on the difference (that is, (Vᵢₙ+)−(Vᵢₙ−)) between the pair of input signals Vᵢₙ+ and Vᵢₙ−, and vₒ(s) may be obtained by performing Laplace transformation on the difference (that is, (Vₒᵤₜ+)−(Vₒᵤₜ−)) between the pair of output signals Vₒᵤₜ+ and Vₒᵤₜ−.

FIG. 8 is a circuit diagram illustrating other respective examples of a second filter circuit and an offset cancellation circuit of a signal processor, according to embodiments.

Referring to FIG. 8, in embodiments, the second filter circuit 220b may include a pair of third resistors 221 and 222 and/or a pair of third capacitors 223 and 224, and the offset cancellation circuit 230b may include a voltage-to-current converter 231b. In the example of FIG. 8, the second filter circuit 220b and the offset cancellation circuit 230b may each be a circuit designed in a differential mode and may be used together with the first filter circuit 210b designed in a differential mode as in the example of FIG. 7.

The pair of third resistors 221 and 222 may each receive an output signal Vₒᵤₜ. That is, the pair of third resistors 221 and 222 may each receive the output signal Vₒᵤₜ via one-side ends (e.g., first ends) thereof. The pair of third resistors 221 and 222 may each have a third resistance R₃.

The pair of third capacitors 223 and 224 may be respectively connected to the pair of third resistors 221 and 222. Here, one-side ends (e.g., first ends) of the pair of third capacitors 223 and 224 may be respectively connected to the other-side ends (e.g., second ends) of the pair of third resistors 221 and 222. The other-side ends (e.g., second ends) of the pair of third capacitors 223 and 224 may be connected to one another. The pair of third capacitors 223 and 224 may each have a third capacitance C₃.

Here, a pair of intermediate signals Vₘ+ and Vₘ− may be respectively output via terminals between the pair of third resistors 221 and 222 and the pair of third capacitors 223 and 224.

Equation 2 may also be derived for the second filter circuit 220b shown in FIG. 8, and here, vₘ(s) may be obtained by performing Laplace transformation on the difference (that is, (Vₘ+)−(Vₘ−)) between the pair of intermediate signals Vₘ+ and Vₘ−.

A pair of input terminals of the voltage-to-current converter 231b may be respectively connected to the terminals between the pair of third resistors 221 and 222 and the pair of third capacitors 223 and 224. Here, the voltage-to-current converter 231b may receive the pair of intermediate signals Vₘ+ and Vₘ− respectively via the pair of input terminals thereof. The voltage-to-current converter 231b may output a pair of feedback signals I_{f}+ and I_{f}− respectively via a pair of output terminals thereof.

Equation 3 may also be derived for the offset cancellation circuit 230b shown in FIG. 8, and here, i_{f}(s) may be obtained by performing Laplace transformation on the difference (that is, (I_{f}+)−(I_{f}−)) between the pair of feedback signals I_{f}+ and I_{f}−.

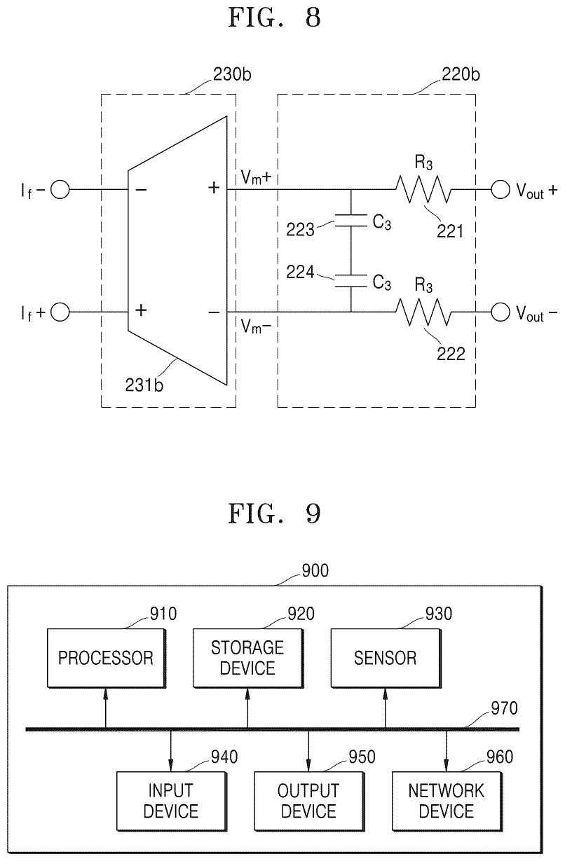

FIG. 9 is a block diagram illustrating a computing device including a radar sensor, according to embodiments.

Referring to FIG. 9, a computing device 900 may perform operations and functions for detecting the distance from an object outside thereof and/or the speed of the object. The computing device 900 may be used for an autonomous driving system, a flight radar system, a driver assistance system, an object recognition system, a surveillance/security system, or the like. The computing device 900 may operate while mounted in, for example, an image processing device, a radar device, a smartphone, a wearable device, a tablet computer, a netbook computer, a laptop computer, a desktop computer, a head-mounted display (HMD), an autonomous driving vehicle, a smart vehicle, and the like.

The computing device 900 may include a processor 910, a storage device 920, a sensor 930, an input device 940, an output device 950, and/or a network device 960. The processor 910, the storage device 920, the sensor 930, the input device 940, the output device 950, and/or the network device 960 may communicate with each other via a communication bus 970.

The processor 910 executes functions and instructions to be executed in the computing device 900. For example, the processor 910 may process instructions stored in the storage device 920.

The storage device 920 stores information or data necessary (or otherwise, used) for a processing operation by the processor 910. The storage device 920 may store instructions to be executed by the processor 910. The storage device 920 may include a non-transitory computer-readable storage medium, for example, random-access memory (RAM), dynamic random-access memory (DRAM), static random-access memory (SRAM), a magnetic hard disk, an optical disk, flash memory, erasable programmable read-only memory (EPROM), or other types of non-transitory computer-readable storage media known in the art.

The sensor 930 may include one or more sensors. The sensor 930 may include a radar sensor, an image sensor, and the like. Here, the radar sensor that is included in the sensor 930 may be implemented by the radar sensor 100 according to embodiments, which is described with reference to FIGS. 1 to 8.

The input device 940 may receive an input from a user via a haptic input, a video input, an audio input, a touch input, etc. The input device 940 may include a keyboard, a mouse, a touch screen, a microphone, or any other device capable of detecting an input from a user and transferring a detected input.

The output device 950 may provide an output of the computing device 900 to a user in a visual, auditory, and/or haptic manner. For example, the output device 950 may include a liquid-crystal display, a light-emitting diode (LED) display, a touch screen, a speaker, a vibration generating device, or any other device capable of providing an output to a user. In embodiments, the output device 950 may provide a result reflecting position information (and/or speed information) of an object, which is estimated by the processor 910, by using one or more of visual information, auditory information, and/or haptic information.

The network device 960 may communicate with an external device via a wired or wireless network. For example, the network device 960 may communicate with an external device by a wired communication method or by a wireless communication method, such as Bluetooth, WiFi, 3-Generation (3G), Long-Term Evolution (LTE), etc.

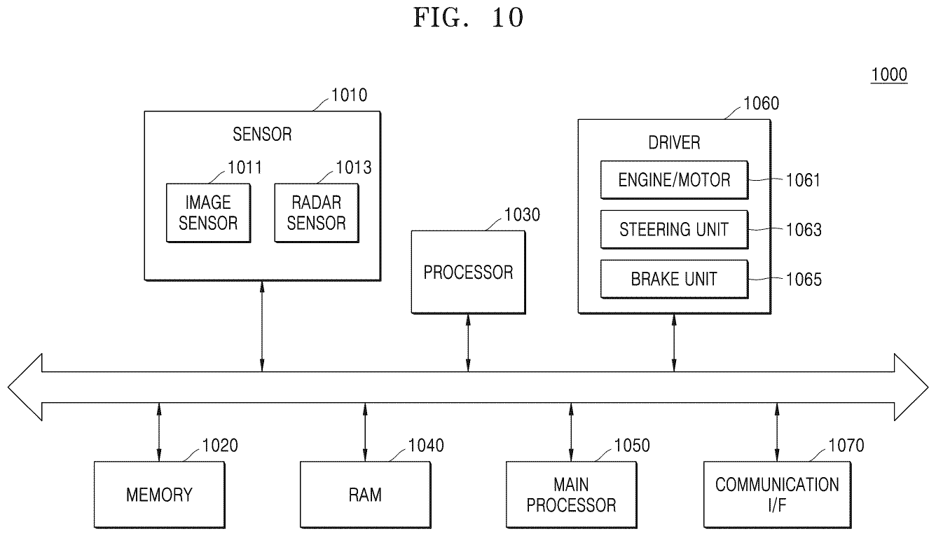

FIG. 10 is a block diagram illustrating an autonomous driving system including a radar sensor, according to embodiments.

Referring to FIG. 10, an autonomous driving device 1000 may include a sensor 1010, a memory 1020, a processor 1030, RAM 1040, a main processor 1050, a driver 1060, and/or a communication interface 1070, and these components of the autonomous driving device 1000 may be communicably connected to each other by a bus.

The sensor 1010 may include a plurality of sensors generating information regarding a surrounding environment of the autonomous driving device 1000. For example, the sensor 1010 may include a plurality of sensors receiving an image signal regarding the surrounding environment of the autonomous driving device 1000 and outputting the received image signal as an image. The sensor 1010 may include an image sensor 1011, such as a charge-coupled device (CCD) and/or a complementary metal oxide semiconductor (CMOS), a radar sensor 1012, and the like. In embodiments, the image sensor 1011 may generate a forward-side image of the autonomous driving device 1000 and provide the forward-side image to the processor 1030. In embodiments, the radar sensor 1012 may detect the distance from an object external thereto and/or the speed of the object. Here, the radar sensor 1012 may be implemented by the radar sensor 100 according to embodiments, which is described with reference to FIGS. 1 to 8.

The memory 1020 is a storage place for storing data and may store, for example, various data generated in the process of performing computation by the main processor 1050 and/or the processor 1030.

The processor 1030 may process various computations related to the sensor 1010.

The main processor 1050 may control all operations of the autonomous driving device 1000. For example, the main processor 1050 may control functions of the processor 1030 by executing programs stored in the RAM 1040. The RAM 1040 may temporarily store programs, data, applications, and/or instructions.

In addition, the main processor 1050 may control operations of the autonomous driving device 1000 based on computation results of the processor 1030. In embodiments, the main processor 1050 may receive information regarding the position and/or speed of a target from the processor 1030, and may control operations of the driver 1060 based on the received information regarding the position and speed of the target.

The driver 1060 is a component for driving the autonomous driving device 1000 and may include an engine-and-motor 1061, a steering unit 1063, and a brake unit 1065. In embodiments, the driver 1060 may adjust propulsion, braking, speed, direction, and the like of the autonomous driving device 1000 by using the engine-and-motor 1061, the steering unit 1063, and/or the brake unit 1065 according to control by the processor 1030. According to embodiments, each among the engine-and-motor 1061, a steering unit 1063, and/or a brake unit 1065 may include a corresponding actuator configured to adjust, for example, a power output by the engine-and-motor 1061, a steering angle of the steering unit 1063, a braking force of the brake unit, etc. According to embodiments, the processor 1030 and/or the main processor 1050 may detect an object external to the autonomous driving device 1000 using the radar sensor 100. For example, the object may represent an obstacle, a target, etc., of the autonomous driving device 1000. According to embodiments, the processor 1030 and/or the main processor 1050 may control the corresponding actuator of the engine-and-motor 1061, the steering unit 1063, and/or the brake unit 1065 based on the detected object (e.g., to avoid the obstacle, move toward the target, etc.). For example, the corresponding actuator may cause one or more support structures of the autonomous driving device 1000 (e.g., wheels, rotors, etc.) to move (e.g., increase, decrease or maintain speed, adjust a steering angle, etc.) under the control of the processor 1030 and/or the main processor 1050.

The communication interface 1070 may perform communication with an external device by a wired or wireless communication method. For example, the communication interface 1070 may perform communication by a wired communication method, such as Ethernet, or by a wireless communication method, such as WiFi or Bluetooth.

Conventional devices and methods for processing a received radar signal (e.g., a radar signal reflected off of an object) involve high-pass filters, low-pass filters and variable-gain amplifiers connected in a cascading manner. Circuits for implementing such filters and amplifiers are initially designed (e.g., relevant parameters of components, operating points, etc., are set) individually, and subsequently adjusted (or redesigned) relative to one another. Such complexity in circuit design results in excessive difficulty and corresponding costs (e.g., manufacturing costs, delay, etc.) in designing the circuits. Also, this complexity increases the difficulty and corresponding costs (e.g., manufacturing costs, delay, etc.) of adjustment of a filtering frequency range of the circuits (e.g., the circuits implementing the high-pass filters and low-pass filters) and/or a gain of the circuits (e.g., the circuits implementing the variable-gain amplifiers). Additionally, the cascaded arrangement of the circuits results in excessive impedance and corresponding power consumption.

However, according to embodiments, improved devices and methods are provided for processing a received radar signal (e.g., a radar signal reflected off of an object). For example, the improved devices and methods may involve first and second filter circuits and an offset cancellation circuit on only a single feedback loop. The singular feedback loop enables the circuits to be designed (e.g., relevant parameters of components, operating points, etc., are set) together at the same time (or contemporaneously), thereby reducing the difficulty and/or costs (e.g., manufacturing costs, delay, etc.) associated with design, and/or adjustment (or redesign) of a filtering frequency range of the circuits (e.g., the circuits implementing the high-pass filters and low-pass filters) and/or a gain of the circuits (e.g., the circuits implementing the variable-gain amplifiers). Also, the singular feedback loop reduces impedance and corresponding power consumption. Therefore, the improved devices and methods overcome the deficiencies of the conventional devices and methods to at least reduce difficulty, costs and/or power consumption.

According to embodiments, operations described herein as being performed by the radar sensor 100, the processor 110, the signal generator 115, the signal distributor 125, the transmission amplifier 130, the reception amplifier 145, the reception frequency converter 150, the signal processor 160, the signal processor 200, the first filter circuit 210, the second filter circuit 220, the offset cancellation circuit 230, the first filter circuit 210a, the amplifier 215a, the second filter circuit 220a, the offset cancellation circuit 230a, the voltage-to-current converter 231a, the first filter circuit 210b, the amplifier 215b, the second filter circuit 220b, the offset cancellation circuit 230b, the voltage-to-current converter 231b, the computing device 900, the processor 910, the sensor 930, the network device 960, the autonomous driving device 1000, the sensor 1010, the processor 1030, the main processor 1050, the driver 1060, and/or the communication interface 1070 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the storage device 920, the memory 1020, the RAM 1040, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

The terms “outside” and/or “external” refers to a region that is beyond the outermost confines of a physical object (e.g., the radar sensor 100, the computing device 900, the autonomous driving device 1000, etc.). The term “inside’ indicates that at least a portion of a region is partially contained within a boundary formed by the object.

Any of the arrows or lines that interconnect the components in the drawings may represent physical data paths, logical data paths, or both. A physical data path may comprise a data bus or a transmission line, for example. A logical data path may represent a communication or data message between software programs, software modules, subroutines, or other software constituents or components. It will be understood that when an element is referred to as being “connected” or “coupled” to another element, it may be directly connected or coupled to the other element or intervening elements may be present.

While the inventive concepts have been particularly shown and described with reference to embodiments thereof, it will be understood that various changes in form and details may be made therein without departing from the spirit and scope of the following claims.

What is claimed is:

1. A signal processor comprising:
a first filter circuit configured to generate an output signal based on an input signal and a feedback signal, the first filter circuit including a first resistor and a first capacitor, a filtering frequency range of the signal processor being set based on a first resistance of the first resistor and a first capacitance of the first capacitor;
a second filter circuit connected to a feedback path of the first filter circuit, the second filter circuit being configured to generate an intermediate signal based on the output signal; and
an offset cancellation circuit connected to the feedback path of the first filter circuit, the offset cancellation circuit being configured to generate the feedback signal based on the intermediate signal.

2. The signal processor of claim 1, wherein a gain of the signal processor is set based on the first resistance.

3. The signal processor of claim 1, wherein the first filter circuit comprises:
the first capacitor configured to receive the input signal;
the first resistor connected in series to the first capacitor;
an amplifier connected to the first resistor via an input terminal of the amplifier;
a second capacitor connected in parallel to the amplifier, the second capacitor being configured to receive the feedback signal, and the second capacitor having a second capacitance; and
a second resistor connected in parallel to the amplifier, the second resistor being configured to receive the feedback signal, and the second resistor having a second resistance.

4. The signal processor of claim 3, wherein a gain of the signal processor is set to be inversely proportional to the first resistance and to be proportional to the second resistance.

5. The signal processor of claim 3, wherein the second filter circuit comprises:
a third resistor configured to receive the output signal, the third resistor having a third resistance; and
a third capacitor connected to the third resistor, the third capacitor having a third capacitance.

6. The signal processor of claim 5, wherein a product of the second resistance and a gain of the offset cancellation circuit is set to be as great as a first reference multiple or more of a reference gain.

7. The signal processor of claim 5, wherein a first value is set to be approximated to a reciprocal of a product of the first resistance and the first capacitance, the first value being obtained by dividing a product of the second resistance and a gain of the offset cancellation circuit by a product of the third resistance and the third capacitance.

8. The signal processor of claim 5, wherein
a reciprocal of a product of the second resistance and the second capacitance is set to be as great as a second reference multiple or more of a reciprocal of a product of the first resistance and the first capacitance; and
the reciprocal of the product of the first resistance and the first capacitance is set to be as great as a third reference multiple or more of a reciprocal of a product of the third resistance and the third capacitance.

9. The signal processor of claim 5, wherein the filtering frequency range of the signal processor is from a first frequency to a second frequency, the first frequency corresponding to a reciprocal of a product of the first resistance and the first capacitance, and the second frequency corresponding to a reciprocal of a product of the second resistance and the second capacitance.

10. A signal processor comprising:
a first filter circuit configured to generate an output signal based on an input signal and a feedback signal, a gain of the signal processor being set based on a first resistance of a first resistor in the first filter circuit;
a second filter circuit connected to a feedback path of the first filter circuit, the second filter circuit being configured to generate an intermediate signal based on the output signal; and
an offset cancellation circuit connected to the feedback path of the first filter circuit, the offset cancellation circuit being configured to generate the feedback signal based on the intermediate signal.

11. The signal processor of claim 10, wherein a filtering frequency range of the signal processor is set based on the first resistance and a first capacitance of a first capacitor in the first filter circuit.

12. The signal processor of claim 10, wherein the first filter circuit comprises:
a pair of first capacitors respectively configured to receive a pair of differential input signals, and each among the pair of first capacitors having a first capacitance;
a pair of first resistors respectively connected in series to the pair of first capacitors, the pair of first resistors including the first resistor, and each among the pair of first resistors having the first resistance;
an amplifier connected to the pair of first resistors respectively via input terminals of the amplifier;
a pair of second capacitors each connected in parallel to the amplifier, and each among the pair of second capacitors being configured to receive the feedback signal, each among the pair of second capacitors having a second capacitance; and
a pair of second resistors each connected in parallel to the amplifier, each among the pair of second resistors being configured to receive the feedback signal, and each among the pair of second resistors having a second resistance.

13. The signal processor of claim 12, wherein the gain of the signal processor is set to be inversely proportional to the first resistance and to be proportional to the second resistance.

14. The signal processor of claim 12, wherein the second filter circuit comprises:
a pair of third resistors respectively configured to receive a pair of differential output signals, each among the pair of third resistors having a third resistance; and
a pair of third capacitors connected in series between the pair of third resistors, and each among the pair of third capacitors having a third capacitance.

15. The signal processor of claim 14, wherein a product of the second resistance and a gain of the offset cancellation circuit is set to be as great as a first reference multiple or more of a reference gain.

16. The signal processor of claim 14, wherein a first value is set to be approximated to a reciprocal of a product of the first resistance and the first capacitance, the first value being obtained by dividing a product of the second resistance and a gain of the offset cancellation circuit by a product of the third resistance and the third capacitance.

17. The signal processor of claim 14, wherein
a reciprocal of a product of the second resistance and the second capacitance is set to be as great as a second reference multiple or more of a reciprocal of a product of the first resistance and the first capacitance; and
the reciprocal of the product of the first resistance and the first capacitance is set to be as great as a third reference multiple or more of a reciprocal of a product of the third resistance and the third capacitance.

18. The signal processor of claim 14, wherein a filtering frequency range of the signal processor is from a first frequency to a second frequency, the first frequency corresponding to a reciprocal of a product of the first resistance and the first capacitance, and the second frequency corresponding to a reciprocal of a product of the second resistance and the second capacitance.

19. A radar sensor comprising:
processing circuitry configured to
generate a transmission signal,
amplify the transmission signal to obtain an amplified transmission signal,
radiate the amplified transmission signal via a transmission antenna,
receive a reception signal via a reception antenna, the reception signal corresponding to a reflection signal resulting from reflection of the transmission signal by an object, and
generate an input signal by amplifying the reception signal; and
a signal processor including
a first filter circuit configured to generate an output signal based on the input signal and a feedback signal, the first filter circuit including a resistor and a capacitor, a filtering frequency range of the signal processor being set based on a resistance of the resistor and a capacitance of the capacitor,
a second filter circuit connected to a feedback path of the first filter circuit, the second filter circuit being configured to generate an intermediate signal based on the output signal, and
an offset cancellation circuit connected to the feedback path of the first filter circuit, the offset cancellation circuit being configured to generate the feedback signal based on the intermediate signal.

20. The radar sensor of claim 19, wherein a gain of the signal processor is set based on the resistance.
